(19) United States
(12) Patent Application Publication
(10) Pub. No.: US 2014/0284056 A1
(43) Pub. Date: Sep. 25, 2014

(54) N-ACYL AMINO ACID ALKYLAMIDE IN OIL-BASED PARTICULATE CARRIER FLUIDS FOR WELL TREATMENTS

(71) Applicant: HALLIBURTON ENERGY SERVICES, INC., Houston, TX (US)

(72) Inventors: Dhanashree Gajanan Kulkarni, Pune (IN); Vikrant Bhavanishankar Wagle, Mumbai (IN)

(73) Assignee: HALLIBURTON ENERGY SERVICES, INC., Houston, TX (US)

(21) Appl. No.: 13/847,919

(22) Filed: Mar. 20, 2013

(51) Int. Cl. C09K 8/80; E21B 43/25

(52) U.S. Cl. CPC C09K 8/80; E21B 43/25
USPC 166/305.1; 507/244

(57) ABSTRACT

A well fluid including: (i) an oleaginous continuous phase; (ii) an N-acyl amino acid alkylamide; and (iii) a solid particulate. A method of treating a portion of a well with a particulate, the method including the steps of: (A) forming the well fluid; and (B) introducing the well fluid into the well. In addition, the N-acyl amino acid alkylamide affords an invert emulsion with a high OWR ratio, that is, greater than 40% oil by volume, for example, 70:30. The invert emulsion has a low viscosity, but can still suspend gravel. In a gravel packing application, the low viscosity of the invert emulsion fluid eliminates the need to break the emulsion during flow-back.

### CROSS-REFERENCE TO RELATED APPLICATIONS

Not applicable.

### TECHNICAL FIELD

The inventions are in the field of producing crude oil or natural gas from subterranean formations. More specifically, the inventions generally relate to oil-based fluids for carrying solid particulates. Such fluid can be used in various well treatments a well, for example, in hydraulic fracturing or gravel packing.

### BACKGROUND

### Well Servicing and Well Fluids

To produce oil or gas from a reservoir, a well is drilled into a subterranean formation, which may be the reservoir or adjacent to the reservoir. Typically, a wellbore of a well must be drilled hundreds or thousands of feet into the earth to reach a hydrocarbon-bearing formation.

Generally, well services include a wide variety of operations that may be performed in oil, gas, geothermal, or water wells, such as drilling, cementing, completion, and intervention. Well services are designed to facilitate or enhance the production of desirable fluids such as oil or gas from or through a subterranean formation. A well service usually involves introducing a well fluid into a well.

Completion is the process of making a well ready for production or injection. This principally involves preparing a zone of the wellbore to the required specifications, running in the production tubing and associated downhole equipment, as well as perforating and stimulating as required.

Intervention is any operation carried out on a well during or at the end of its productive life that alters the state of the well or well geometry, provides well diagnostics, or manages the production of the well. Workover can broadly refer to any kind of well intervention that involves invasive techniques, such as wireline, coiled tubing, or snubbing. More specifically, however, workover usually refers to a process of pulling and replacing a completion.

Well services can include various types of treatments that are commonly performed in a wellbore or subterranean formation. For example, stimulation is a type of treatment performed to enhance or restore the productivity of oil or gas from a well. Even small improvements in fluid flow can yield dramatic production results.

Stimulation treatments fall into two main groups: hydraulic fracturing and matrix treatments. Fracturing treatments are performed above the fracture pressure of the subterranean formation to create or extend a highly permeable flow path between the formation and the wellbore. Matrix treatments are performed below the fracture pressure of the formation. Fracturing treatments are often applied in treatment zones having poor natural permeability. Matrix treatments are often applied in treatment zones having good natural permeability to counteract damage in the near-wellbore area.

Other types of completion or intervention treatments can include, for example, gravel packing, consolidation, and controlling excessive water production. Still other types of completion or intervention treatments include, but are not limited to, damage removal, formation isolation, wellbore cleanout, scale removal, and scale control.

### Carrier Fluid for Particulate

A well fluid can be adapted to be a carrier fluid for particulates. For example, a proppant used in fracturing or a gravel used in gravel packing may have a much different density than the carrier fluid. For example, sand has a specific gravity of about 2.7, whereas water has a specific gravity of 1.0 at Standard Laboratory Conditions of temperature and pressure. A proppant or gravel having a different density than water will tend to separate from water very rapidly.

A viscosity-increasing agent can be used to increase the ability of a fluid to suspend and carry a particulate material in a well fluid. A viscosity-increasing agent can be used for other purposes, such as matrix diversion, conformance control, or friction reduction.

A viscosity-increasing agent is sometimes referred to in the art as a viscosifying agent, viscosifier, thickener, gelling agent, or suspending agent. In general, any of these refers to an agent that includes at least the characteristic of increasing the viscosity of a fluid in which it is dispersed or dissolved. There are several kinds of viscosity-increasing agents or techniques for increasing the viscosity of a fluid.

### Breaker for Viscosity of Fluid or Filtercake

After a treatment fluid is placed where desired in the well and for the desired time, the fluid usually must be removed from the wellbore or the formation. For example, in the case of hydraulic fracturing, the fluid should be removed leaving the proppant in the fracture and without damaging the conductivity of the proppant bed. To accomplish this removal, the viscosity of the treatment fluid must be reduced to a very low viscosity, preferably near the viscosity of water, for optimal removal from the propped fracture. Similarly, when a viscosified fluid is used for gravel packing, the viscosified fluid must be removed from the gravel pack.

Reducing the viscosity of a viscosified treatment fluid is referred to as “breaking” the fluid. Chemicals used to reduce the viscosity of treatment fluids are called breakers. Other types of viscosified well fluids also need to be broken for removal from the wellbore or subterranean formation.

No particular mechanism is necessarily implied by the term. For example, a breaker can reduce the molecular weight of a water-soluble polymer by cutting the long polymer chain. As the length of the polymer chain is cut, the viscosity of the fluid is reduced. This process can occur independently of any crosslinking bonds existing between polymer chains.

### Emulsion for Increasing Viscosity

An approach to increasing the viscosity of a fluid is the use of an emulsion. The internal-phase droplets of an emulsion disrupt flow streamlines and require more effort to get the same flow rate. Thus, an emulsion tends to have a higher viscosity than the external phase of the emulsion would otherwise have by itself. This property of an emulsion can be used to help suspend a particulate material in an emulsion. This technique for increasing the viscosity of a liquid can be used separately or in combination with other techniques for increasing the viscosity of a fluid.

As used herein, to “break,” in regard to an emulsion, means to cause the creaming and coalescence of emulsified drops of the internal dispersed phase so that the internal phase separates out of the external phase. Breaking an emulsion can be accomplished mechanically (for example, in settlers, cyclones, or centrifuges), or via dilution, or with chemical additives to increase the surface tension of the internal droplets.

### Gravel Packing

Gravel pack fluids have been used to control sand production in unconsolidated wells. Conventional gravel pack fluid comprises water as the carrier fluid. However, selection of water as carrier fluid would be best avoided in the case of water-sensitive formations. In addition, many wellbores require a more lubricious carrier fluid, which unfortunately the water-based carrier fluids do not provide. Oil-based gravel pack fluids are of importance particularly in water sensitive formations. In addition to the inhibitive property towards the water-sensitive formation, it also provides lubricity, which lowers friction pressures in the well Inhibitive property in this context means ability of the invert emulsion fluid to inhibit swelling of the reactive clay.

The invert emulsion based gravel-pack fluids that are currently being used in the industry have a typical oil:water ratio (OWR) of about 30:70, i.e., the oil content is less than the water content. Such an OWR provides good viscosity to the invert emulsion carrier fluid, whereby it increases the ability of the fluid to suspend sand (gravel). However, a major disadvantage of such an OWR is that it is required to break the brine-in-oil emulsion so as to lower the fluid viscosity during flow-back. Friction pressures required are also higher in such a fluid.

### SUMMARY OF THE INVENTION

The present invention relates to an oil-based carrier fluid for a particulate, which can be used, for example, to gravel pack a well.

In an embodiment, a well fluid is provided, the well fluid including: (i) an oleaginous continuous phase; (ii) an N-acyl amino acid alkylamide; and (iii) a solid particulate.

In another embodiment, a method of treating a portion of a well with a particulate is provided, the method including the steps of: (A) forming the well fluid; and (B) introducing the well fluid into the well.

Preferably, the N-acyl amino acid alkylamide is represented by formula:

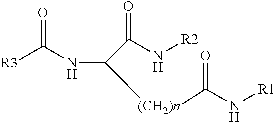

wherein R1 and R2 each independently represent a straight chain or branched chain saturated or unsaturated hydrocarbon group having 1 to 30 carbon atoms,
wherein R3 represents a straight chain or branched chain saturated or unsaturated hydrocarbon group having 1 to 30 carbon atoms, and
wherein n represents 1 or 2.

In another embodiment, a well fluid in the form of an invert emulsion is provided. The N-acyl amino acid alkylamide affords an invert emulsion with a high OWR ratio, that is, greater than 40% oil by volume, for example, 70:30. The invert emulsion has a low viscosity, but can still suspend gravel. The low viscosity of the invert emulsion fluid eliminates the need to break the emulsion during flow-back.

These and other aspects of the invention will be apparent to one skilled in the art upon reading the following detailed description. While the invention is susceptible to various modifications and alternative forms, specific embodiments thereof will be described in detail and shown by way of example. It should be understood, however, that it is not intended to limit the invention to the particular forms disclosed, but, on the contrary, the invention is to cover all modifications and alternatives falling within the spirit and scope of the invention as expressed in the appended claims.

### DETAILED DESCRIPTION OF PRESENTLY PREFERRED EMBODIMENTS AND BEST MODE

### Definitions and Usages

General Interpretation

The words or terms used herein have their plain, ordinary meaning in the field of this disclosure, except to the extent explicitly and clearly defined in this disclosure or unless the specific context otherwise requires a different meaning.

If there is any conflict in the usages of a word or term in this disclosure and one or more patent(s) or other documents that may be incorporated by reference, the definitions that are consistent with this specification should be adopted.

The words “comprising,” “containing,” “including,” “having,” and all grammatical variations thereof are intended to have an open, non-limiting meaning. For example, a composition comprising a component does not exclude it from having additional components, an apparatus comprising a part does not exclude it from having additional parts, and a method having a step does not exclude it having additional steps. When such terms are used, the compositions, apparatuses, and methods that “consist essentially of” or “consist of” the specified components, parts, and steps are specifically included and disclosed.

The indefinite articles “a” or “an” mean one or more than one of the component, part, or step that the article introduces.

Whenever a numerical range of degree or measurement with a lower limit and an upper limit is disclosed, any number and any range falling within the range is also intended to be specifically disclosed. For example, every range of values (in the form “from a to b,” or “from about a to about b,” or “from about a to b,” “from approximately a to b,” and any similar expressions, where “a” and “b” represent numerical values of degree or measurement) is to be understood to set forth every number and range encompassed within the broader range of values.

It should be understood that algebraic variables and other scientific symbols used herein are selected arbitrarily or according to convention. Other algebraic variables can be used.

Oil and Gas Reservoirs

In the context of production from a well, “oil” and “gas” are understood to refer to crude oil and natural gas, respectively. Oil and gas are naturally occurring hydrocarbons in certain subterranean formations.

A “subterranean formation” is a body of rock that has sufficiently distinctive characteristics and is sufficiently continuous for geologists to describe, map, and name it.

A subterranean formation having a sufficient porosity and permeability to store and transmit fluids is sometimes referred to as a “reservoir.”

A subterranean formation containing oil or gas may be located under land or under the seabed off shore. Oil and gas reservoirs are typically located in the range of a few hundred feet (shallow reservoirs) to a few tens of thousands of feet (ultra-deep reservoirs) below the surface of the land or seabed.

A consolidated formation is a geologic material for which the particles are stratified (layered), cemented, or firmly packed together (hard rock); usually occurring at a depth below the ground surface. An unconsolidated formation is a sediment that is loosely arranged or unstratified (not in layers) or whose particles are not cemented together (soft rock); occurring either at the ground surface or at a depth below the surface.

A water-sensitive formation is a formation that includes reactive clays, that is, clays that swell when they come in contact with water. Examples of such clays include smectite and illite.

Well Terms

A “well” includes a wellhead and at least one wellbore from the wellhead penetrating the earth. The “wellhead” is the surface termination of a wellbore, which surface may be on land or on a seabed.

A “well site” is the geographical location of a wellhead of a well. It may include related facilities, such as a tank battery, separators, compressor stations, heating or other equipment, and fluid pits. If offshore, a well site can include a platform.

The “wellbore” refers to the drilled hole, including any cased or uncased portions of the well or any other tubulars in the well. The “borehole” usually refers to the inside wellbore wall, that is, the rock surface or wall that bounds the drilled hole. A wellbore can have portions that are vertical, horizontal, or anything in between, and it can have portions that are straight, curved, or branched. As used herein, “uphole,” “downhole,” and similar terms are relative to the direction of the wellhead, regardless of whether a wellbore portion is vertical or horizontal.

A wellbore can be used as a production or injection wellbore. A production wellbore is used to produce hydrocarbons from the reservoir. An injection wellbore is used to inject a fluid, e.g., liquid water or steam, to drive oil or gas to a production wellbore.

As used herein, introducing “into a well” means introducing at least into and through the wellhead. According to various techniques known in the art, tubulars, equipment, tools, or well fluids can be directed from the wellhead into any desired portion of the wellbore.

As used herein, a “well fluid” broadly refers to any fluid adapted to be introduced into a well for any purpose. A well fluid can be, for example, a drilling fluid, a setting composition, a treatment fluid, or a spacer fluid. If a well fluid is to be used in a relatively small volume, for example less than about 200 barrels (about 8,400 US gallons or about 32 m³), it is sometimes referred to as a wash, dump, slug, or pill.

As used herein, the word “treatment” refers to any treatment for changing a condition of a portion of a wellbore, or a subterranean formation adjacent a wellbore; however, the word “treatment” does not necessarily imply any particular treatment purpose. A treatment usually involves introducing a well fluid for the treatment, in which case it may be referred to as a treatment fluid, into a well. As used herein, a “treatment fluid” is a well fluid used in a treatment. The word “treatment” in the term “treatment fluid” does not necessarily imply any particular treatment or action by the fluid.

A “portion” of a well refers to any downhole portion of the well.

A “zone” refers to an interval of rock along a wellbore that is differentiated from uphole and downhole zones based on hydrocarbon content or other features, such as permeability, composition, perforations or other fluid communication with the wellbore, faults, or fractures. A zone of a wellbore that penetrates a hydrocarbon-bearing zone that is capable of producing hydrocarbon is referred to as a “production zone.” A “treatment zone” refers to an interval of rock along a wellbore into which a well fluid is directed to flow from the wellbore. As used herein, “into a treatment zone” means into and through the wellhead and, additionally, through the wellbore and into the treatment zone.

As used herein, a “downhole” fluid (or gel) is an in-situ fluid in a well, which may be the same as a well fluid at the time it is introduced, or a well fluid mixed with another fluid downhole, or a fluid in which chemical reactions are occurring or have occurred in-situ downhole.

Fluid loss refers to the undesirable leakage of a fluid phase of any type of well fluid into the permeable matrix of a zone, which zone may or may not be a treatment zone. Fluid-loss control refers to treatments designed to reduce such undesirable leakage.

Generally, the greater the depth of the formation, the higher the static temperature and pressure of the formation. Initially, the static pressure equals the initial pressure in the formation before production. After production begins, the static pressure approaches the average reservoir pressure.

A “design” refers to the estimate or measure of one or more parameters planned or expected for a particular fluid or stage of a well service or treatment. For example, a fluid can be designed to have components that provide a minimum density or viscosity for at least a specified time under expected downhole conditions. A well service may include design parameters such as fluid volume to be pumped, required pumping time for a treatment, or the shear conditions of the pumping.

The term “design temperature” refers to an estimate or measurement of the actual temperature at the downhole environment during the time of a treatment. For example, the design temperature for a well treatment takes into account not only the bottom hole static temperature (“BHST”), but also the effect of the temperature of the well fluid on the BHST during treatment. The design temperature for a well fluid is sometimes referred to as the bottom hole circulation temperature (“BHCT”). Because well fluids may be considerably cooler than BHST, the difference between the two temperatures can be quite large. Ultimately, if left undisturbed, a subterranean formation will return to the BHST.

Substances and Phases

A substance can be a pure chemical or a mixture of two or more different chemicals.

As used herein, “phase” is used to refer to a substance having a chemical composition and physical state that is distinguishable from an adjacent phase of a substance having a different chemical composition or a different physical state.

As used herein, if not other otherwise specifically stated, the physical state or phase of a substance (or mixture of substances) and other physical properties are determined at a temperature of 77° F. (25° C.) and a pressure of 1 atmosphere (Standard Laboratory Conditions) without applied shear.

Particles and Particulates

As used herein, a “particle” refers to a body having a finite mass and sufficient cohesion such that it can be considered as an entity but having relatively small dimensions. A particle can be of any size ranging from molecular scale to macroscopic, depending on context.

A particle can be in any physical state. For example, a particle of a substance in a solid state can be as small as a few molecules on the scale of nanometers up to a large particle on the scale of a few millimeters, such as large grains of sand. Similarly, a particle of a substance in a liquid state can be as small as a few molecules on the scale of nanometers up to a large drop on the scale of a few millimeters. A particle of a substance in a gas state is a single atom or molecule that is separated from other atoms or molecules such that intermolecular attractions have relatively little effect on their respective motions.

As used herein, particulate or particulate material refers to matter in the physical form of distinct particles in a solid or liquid state (which means such an association of a few atoms or molecules). As used herein, a particulate is a grouping of particles having similar chemical composition and particle size ranges anywhere in the range of about 0.5 micrometer (500 nm), e.g., microscopic clay particles, to about 3 millimeters, e.g., large grains of sand.

A particulate can be of solid or liquid particles. As used herein, however, unless the context otherwise requires, particulate refers to a solid particulate. Of course, a solid particulate is a particulate of particles that are in the solid physical state, that is, the constituent atoms, ions, or molecules are sufficiently restricted in their relative movement to result in a fixed shape for each of the particles.

It should be understood that the terms “particle” and “particulate,” includes all known shapes of particles including substantially rounded, spherical, oblong, ellipsoid, rod-like, fiber, polyhedral (such as cubic materials), etc., and mixtures thereof. For example, the term “particulate” as used herein is intended to include solid particles having the physical shape of platelets, shavings, flakes, ribbons, rods, strips, spheroids, toroids, pellets, tablets or any other physical shape.

As used herein, a fiber is a particle or grouping of particles having an aspect ratio L/D greater than 5/1.

A particulate will have a particle size distribution (“PSD”). As used herein, “the size” of a particulate can be determined by methods known to persons skilled in the art.

One way to measure the approximate particle size distribution of a solid particulate is with graded screens. A solid particulate material will pass through some specific mesh (that is, have a maximum size; larger pieces will not fit through this mesh) but will be retained by some specific tighter mesh (that is, a minimum size; pieces smaller than this will pass through the mesh). This type of description establishes a range of particle sizes. A “+” before the mesh size indicates the particles are retained by the sieve, while a “−” before the mesh size indicates the particles pass through the sieve. For example, −70/+140 means that 90% or more of the particles will have mesh sizes between the two values.

Particulate materials are sometimes described by a single mesh size, for example, 100 U.S. Standard mesh. If not otherwise stated, a reference to a single particle size means about the mid-point of the industry-accepted mesh size range for the particulate.

Particulates smaller than about 400 U.S. Standard Mesh are usually measured or separated according to other methods because small forces such as electrostatic forces can interfere with separating tiny particulate sizes using a wire mesh.

The most commonly-used grade scale for classifying the diameters of sediments in geology is the Udden-Wentworth scale. According to this scale, a solid particulate having particles smaller than 2 mm in diameter is classified as sand, silt, or clay. Sand is a detrital grain between 2 mm (equivalent to 2,000 micrometers) and 0.0625 mm (equivalent to 62.5 micrometers) in diameter. (Sand is also a term sometimes used to refer to quartz grains or for sandstone.) Silt refers to particulate between 74 micrometers (equivalent to about −200 U.S. Standard mesh) and about 2 micrometers. Clay is a particulate smaller than 0.0039 mm (equivalent to 3.9 μm).

Dispersions

A dispersion is a system in which particles of a substance of one chemical composition and physical state are dispersed in another substance of a different chemical composition or physical state. In addition, phases can be nested. If a substance has more than one phase, the most external phase is referred to as the continuous phase of the substance as a whole, regardless of the number of different internal phases or nested phases.

A dispersion can be classified in different ways, including, for example, based on the size of the dispersed particles, the uniformity or lack of uniformity of the dispersion, and, if a fluid, by whether or not precipitation occurs.

A dispersion is considered to be heterogeneous if the dispersed particles are not dissolved and are greater than about 1 nanometer in size. (For reference, the diameter of a molecule of toluene is about 1 nm and a molecule of water is about 0.3 nm).

Heterogeneous dispersions can have gas, liquid, or solid as an external phase. For example, in a case where the dispersed-phase particles are liquid in an external phase that is another liquid, this kind of heterogeneous dispersion is more particularly referred to as an emulsion. A solid dispersed phase in a continuous liquid phase is referred to as a sol, suspension, or slurry, partly depending on the size of the dispersed solid particulate.

A dispersion is considered to be homogeneous if the dispersed particles are dissolved in solution or the particles are less than about 1 nanometer in size. Even if not dissolved, a dispersion is considered to be homogeneous if the dispersed particles are less than about 1 nanometer in size.

Heterogeneous dispersions can be further classified based on the dispersed particle size.

A heterogeneous dispersion is a “suspension” where the dispersed particles are larger than about 50 micrometers. Such particles can be seen with a microscope, or if larger than about 50 micrometers (0.05 mm), with the unaided human eye. The dispersed particles of a suspension in a liquid external phase may eventually separate on standing, e.g., settle in cases where the particles have a higher density than the liquid phase. Suspensions having a liquid external phase are essentially unstable from a thermodynamic point of view; however, they can be kinetically stable over a long period depending on temperature and other conditions.

A heterogeneous dispersion is a “colloid” where the dispersed particles range up to about 50 micrometer (50,000 nanometers) in size. The dispersed particles of a colloid are so small that they settle extremely slowly, if ever. In some cases, a colloid can be considered as a homogeneous mixture. This is because the distinction between “dissolved” and “particulate” matter can be sometimes a matter of theoretical approach, which affects whether or not it is considered homogeneous or heterogeneous.

A solution is a special type of homogeneous mixture. A solution is considered homogeneous: (a) because the ratio of solute to solvent is the same throughout the solution; and (b) because solute will never settle out of solution, even under powerful centrifugation, which is due to intermolecular attraction between the solvent and the solute. An aqueous solution, for example, saltwater, is a homogenous solution in which water is the solvent and salt is the solute.

One may also refer to the solvated state, in which a solute ion or molecule is complexed by solvent molecules. A chemical that is dissolved in solution is in a solvated state. The solvated state is distinct from dissolution and solubility. Dissolution is a kinetic process, and is quantified by its rate. Solubility quantifies the concentration of the solute at which there is dynamic equilibrium between the rate of dissolution and the rate of precipitation of the solute. Dissolution and solubility can be dependent on temperature and pressure, and may be dependent on other factors, such as salinity or pH of an aqueous phase.

Solubility

A substance is considered to be “soluble” in a liquid if at least 10 grams of the substance can be hydrated or dissolved in one liter of the liquid (which is at least 83 ppt) when tested at 77° F. and 1 atmosphere pressure for 2 hours, considered to be “insoluble” if less than 1 gram per liter (which is less than 8.3 ppt), and considered to be “sparingly soluble” for intermediate solubility values.

As will be appreciated by a person of skill in the art, the hydratability, dispersibility, or solubility of a substance in water can be dependent on the salinity, pH, or other substances in the water. Accordingly, the salinity, pH, and additive selection of the water can be modified to facilitate the hydratability, dispersibility, or solubility of a substance in aqueous solution. To the extent not specified, the hydratability, dispersibility, or solubility of a substance in water is determined in deionized water, at neutral pH, and without any other additives.

As used herein, the term “polar” means having a dielectric constant greater than 30. The term “relatively polar” means having a dielectric constant greater than about 2 and less than about 30. “Non-polar” means having a dielectric constant less than 2.

Fluids

A fluid can be a single phase or a dispersion. In general, a fluid is an amorphous substance that is or has a continuous phase of particles that are smaller than about 1 micrometer that tends to flow and to conform to the outline of its container.

Examples of fluids are gases and liquids. A gas (in the sense of a physical state) refers to an amorphous substance that has a high tendency to disperse (at the molecular level) and a relatively high compressibility. A liquid refers to an amorphous substance that has little tendency to disperse (at the molecular level) and relatively high incompressibility. The tendency to disperse is related to Intermolecular Forces (also known as van der Waal's Forces). (A continuous mass of a particulate, e.g., a powder or sand, can tend to flow as a fluid depending on many factors such as particle size distribution, particle shape distribution, the proportion and nature of any wetting liquid or other surface coating on the particles, and many other variables. Nevertheless, as used herein, a fluid does not refer to a continuous mass of particulate as the sizes of the solid particles of a mass of a particulate are too large to be appreciably affected by the range of Intermolecular Forces.)

Every fluid inherently has at least a continuous phase. A fluid can have more than one phase. The continuous phase of a well fluid is a liquid under Standard Laboratory Conditions. For example, a well fluid can be in the form of a suspension (larger solid particles dispersed in a liquid phase), a sol (smaller solid particles dispersed in a liquid phase), an emulsion (liquid particles dispersed in another liquid phase), or a foam (a gas phase dispersed in a liquid phase).

As used herein, a “water-based” fluid means that water or an aqueous solution is the dominant material of the continuous phase, that is, greater than 50% by weight, of the continuous phase of the fluid based on the combined weight of water and any other solvents in the phase (that is, excluding the weight of any dissolved solids).

In contrast, an “oil-based” fluid means that oil is the dominant material by weight of the continuous phase of the fluid. In this context, the oil of an oil-based fluid can be any oil.

In the context of a well fluid, oil is understood to refer to an oil liquid, whereas gas is understood to refer to a physical state of a substance, in contrast to a liquid. In this context, an oil is any substance that is liquid under Standard Laboratory Conditions, is hydrophobic, and soluble in organic solvents. Oils typically have a high carbon and hydrogen content and are non-polar substances. This general definition includes classes such as petrochemical oils, vegetable oils, and many organic solvents. All oils, even synthetic oils, can be traced back to organic sources.

Emulsions

An emulsion is a fluid including a dispersion of immiscible liquid particles in an external liquid phase. In addition, the proportion of the external and internal phases is above the solubility of either in the other. A chemical can be included to reduce the interfacial tension between the two immiscible liquids to help with stability against coalescing of the internal liquid phase, in which case the chemical may be referred to as a surfactant or more particularly as an emulsifier or emulsifying agent.

In the context of an emulsion, a “water phase” refers to a phase of water or an aqueous solution and an “oil phase” refers to a phase of any non-polar, organic liquid that is immiscible with water, usually an oil.

An emulsion can be an oil-in-water (o/w) type or water-in-oil (w/o) type. A water-in-oil emulsion is sometimes referred to as an invert emulsion.

It should be understood that multiple emulsions are possible. These are sometimes referred to as nested emulsions. Multiple emulsions are complex polydispersed systems where both oil-in-water and water-in-oil emulsions exist simultaneously in the fluid, wherein the oil-in-water emulsion is stabilized by a lipophilic surfactant and the water-in-oil emulsion is stabilized by a hydrophilic surfactant. These include water-in-oil-in-water (w/o/w) and oil-in-water-in-oil (o/w/o) type multiple emulsions. Even more complex polydispersed systems are possible. Multiple emulsions can be formed, for example, by dispersing a water-in-oil emulsion in water or an aqueous solution, or by dispersing an oil-in-water emulsion in oil.

A stable emulsion is an emulsion that will not cream, flocculate, or coalesce under certain conditions, including time and temperature. As used herein, the term “cream” means at least some of the droplets of a dispersed phase converge towards the surface or bottom of the emulsion (depending on the relative densities of the liquids making up the continuous and dispersed phases). The converged droplets maintain a discrete droplet form. As used herein, the term “flocculate” means at least some of the droplets of a dispersed phase combine to form small aggregates in the emulsion. As used herein, the term “coalesce” means at least some of the droplets of a dispersed phase combine to form larger drops in the emulsion.

Surfactants

Surfactants are compounds that lower the surface tension of a liquid, the interfacial tension between two liquids, or that between a liquid and a solid, or that between a liquid and a gas. Surfactants may act as detergents, wetting agents, emulsifiers, foaming agents, and dispersants.

Surfactants are usually organic compounds that are amphiphilic, meaning they contain both hydrophobic groups (“tails”) and hydrophilic groups (“heads”). Therefore, a surfactant contains both a water-insoluble (or oil soluble) portion and a water-soluble portion.

A surfactant can be or include a cationic, a zwitterionic, or a nonionic emulsifier. A surfactant package can include one or more different chemicals. As used herein, a surfactant does not mean or include a hydrophobic particulate.

In a water phase, surfactants form aggregates, such as micelles, where the hydrophobic tails form the core of the aggregate and the hydrophilic heads are in contact with the surrounding liquid. The aggregates can be formed in various shapes such as spherical or cylindrical micelles or bilayers. The shape of the aggregation depends upon various factors such as the chemical structure of the surfactant (e.g., the balance of the sizes of the hydrophobic tail and hydrophilic head), the concentration of the surfactant, nature of counter ions, ionic salt concentration, co-surfactants, solubilized components (if any), pH, and temperature.

As used herein, the term micelle includes any structure that minimizes the contact between the lyophobic (“solvent-repelling”) portion of a surfactant molecule and the solvent, for example, by aggregating the surfactant molecules into structures such as spheres, cylinders, or sheets, wherein the lyophobic portions are on the interior of the aggregate structure and the lyophilic (“solvent-attracting”) portions are on the exterior of the structure. Micelles can function, among other purposes, to stabilize emulsions, break emulsions, stabilize a foam, change the wettability of a surface, or solubilize certain materials.

The hydrophilic-lipophilic balance (“HLB”) of a surfactant is a measure of the degree to which it is hydrophilic or lipophilic, determined by calculating values for the different regions of the molecule, as described by Griffin in 1949 and 1954. Other methods have been suggested, notably in 1957 by Davies.

In general, Griffin's method for non-ionic surfactants as described in 1954 works as follows:

HLB=20*Mh/M

where Mh is the molecular mass of the hydrophilic portion of the molecule, and M is the molecular mass of the whole molecule, giving a result on a scale of 0 to 20. An HLB value of 0 corresponds to a completely lipidphilic/hydrophobic molecule, and a value of 20 corresponds to a completely hydrophilic/lypidphobic molecule. Griffin WC: “Classification of Surface-Active Agents by ‘HLB,’” Journal of the Society of Cosmetic Chemists 1 (1949): 311. Griffin WC: “Calculation of HLB Values of Non-Ionic Surfactants,” Journal of the Society of Cosmetic Chemists 5 (1954): 249.

The HLB (Griffin) value can be used to predict the surfactant properties of a molecule, where a value less than 10 indicates that the surfactant molecule is lipid soluble (and water insoluble), whereas a value greater than 10 indicates that the surfactant molecule is water soluble (and lipid insoluble).

The HLB (Griffin) value can be used to predict the uses of the molecule, for example, where: a value from 4 to 6 indicates a W/O (water in oil) emulsifier, and a value from 8 to 18 indicates O/W (oil in water) emulsifier.

Emulsifier

As used herein, an “emulsifier” refers to a type of surfactant that helps prevent the droplets of the dispersed phase of an emulsion from flocculating or coalescing in the emulsion.

The emulsifier is preferably in a concentration of at least 1% by weight of the water of the emulsion. More preferably, the emulsifier is in a concentration in the range of 1% to 10% by weight of the water.

An emulsion can also include other additives. For example, the emulsion can contain a freezing-point depressant. More preferably, the freezing point depressant is for the water of the continuous phase. Preferably, the freezing-point depressant is selected from the group consisting of water soluble ionic salts, alcohols, glycols, urea, and any combination thereof in any proportion.

An emulsion can also contain water-soluble salt(s) at a high-ionic strength for other purposes, for example, to increase the density of the continuous phase of the emulsion. Preferably, the water-soluble salt is selected from the group consisting of: an alkali metal halide, alkaline earth halide, alkali metal formate, and any combination thereof.

Preferably, an emulsion should be stable under one or more of certain conditions commonly encountered in the storage and use of such an emulsion composition for a well treatment operation.

Apparent Viscosity of a Fluid

Viscosity is a measure of the resistance of a fluid to flow. In everyday terms, viscosity is “thickness” or “internal friction.” Thus, pure water is “thin,” having a relatively low viscosity whereas honey is “thick,” having a relatively higher viscosity. Put simply, the less viscous the fluid is, the greater its ease of movement (fluidity). More precisely, viscosity is defined as the ratio of shear stress to shear rate.

A fluid moving along solid boundary will incur a shear stress on that boundary. The no-slip condition dictates that the speed of the fluid at the boundary (relative to the boundary) is zero, but at some distance from the boundary the flow speed must equal that of the fluid. The region between these two points is aptly named the boundary layer. For all Newtonian fluids in laminar flow, the shear stress is proportional to the strain rate in the fluid where the viscosity is the constant of proportionality. However for non-Newtonian fluids, this is no longer the case as for these fluids the viscosity is not constant. The shear stress is imparted onto the boundary as a result of this loss of velocity.

A Newtonian fluid (named after Isaac Newton) is a fluid for which stress versus strain rate curve is linear and passes through the origin. The constant of proportionality is known as the viscosity. Examples of Newtonian fluids include water and most gases. Newton's law of viscosity is an approximation that holds for some substances but not others.

Non-Newtonian fluids exhibit a more complicated relationship between shear stress and velocity gradient (i.e., shear rate) than simple linearity. Thus, there exist a number of forms of non-Newtonian fluids. Shear thickening fluids have an apparent viscosity that increases with increasing the rate of shear. Shear thinning fluids have a viscosity that decreases with increasing rate of shear. Thixotropic fluids become less viscous over time at a constant shear rate. Rheopectic fluids become more viscous over time at a constant shear rate. A Bingham plastic is a material that behaves as a solid at low stresses but flows as a viscous fluid at high yield stresses.

Most well fluids are non-Newtonian fluids. Accordingly, the apparent viscosity of a fluid applies only under a particular set of conditions including shear stress versus shear rate, which must be specified or understood from the context. As used herein, a reference to viscosity is actually a reference to an apparent viscosity. Apparent viscosity is commonly expressed in units of mPa·s or centipoise (cP), which are equivalent.

Like other physical properties, the viscosity of a Newtonian fluid or the apparent viscosity of a non-Newtonian fluid may be highly dependent on the physical conditions, primarily temperature and pressure.

Gels and Deformation

The physical state of a gel is formed by a network of interconnected molecules, such as a crosslinked polymer or a network of micelles. The network gives a gel phase its structure and an apparent yield point. At the molecular level, a gel is a dispersion in which both the network of molecules is continuous and the liquid is continuous. A gel is sometimes considered as a single phase.

Technically, a “gel” is a semi-solid, jelly-like physical state or phase that can have properties ranging from soft and weak to hard and tough. Shearing stresses below a certain finite value fail to produce permanent deformation. The minimum shear stress which will produce permanent deformation is referred to as the shear strength or gel strength of the gel.

In the oil and gas industry, however, the term “gel” may be used to refer to any fluid having a viscosity-increasing agent, regardless of whether it is a viscous fluid or meets the technical definition for the physical state of a gel.

As used herein, a substance referred to as a “gel” is subsumed by the concept of “fluid” if it is a pumpable fluid.

Viscosity and Gel Measurements

There are numerous ways of measuring and modeling viscous properties, and new developments continue to be made. The methods depend on the type of fluid for which viscosity is being measured. A typical method for quality assurance or quality control (QA/QC) purposes uses a couette device, such as a FANN™ Model 35 or 50 viscometer or a CHANDLER™ 5550 HPHT viscometer. Such a viscometer measures viscosity as a function of time, temperature, and shear rate. The viscosity-measuring instrument can be calibrated using standard viscosity silicone oils or other standard viscosity fluids.

In general, a FANN™ Model 35 viscometer is used for viscosity measurements of less than about 40 cP. In addition, the Model 35 does not have temperature and pressure controls, so it is used for fluids at ambient conditions (that is, Standard Laboratory Conditions). Except to the extent otherwise specified, the apparent viscosity of a fluid having a viscosity of less than about 30 cP (excluding any suspended solid particulate larger than silt) is measured with a FANN™ Model 35 type viscometer with a bob and cup geometry using an R1 rotor, B1 bob, and F1 torsion spring at a shear rate of 511 l/s (300 rpm) and at a temperature of 77° F. (25° C.) and a pressure of 1 atmosphere.

In general, a FANN™ Model 50 viscometer is used for viscosity measurements of greater than about 40 cP. The Model 50 has temperature and pressure controls. Except to the extent otherwise specified, the apparent viscosity of a fluid having a viscosity of greater than about 35 cP (excluding any suspended solid particulate larger than silt) is measured with a FANN™ Model 50 type viscometer with a bob and cup geometry using an R1 rotor, B5 bob, and 420 or 440 spring at a shear rate of 40 sec-1 (47 rpm) and at a temperature of 77° F. (25° C.) and pressure about 500 psi.

Due to the geometry of most common viscosity-measuring devices, however, solid particulate, especially if larger than silt (larger than 74 micron), would interfere with the measurement on some types of measuring devices. Therefore, the viscosity of a fluid containing such solid particulate is usually inferred and estimated by measuring the viscosity of a test fluid that is similar to the fracturing fluid without any proppant or gravel that would otherwise be included. However, as suspended particles (which can be solid, gel, liquid, or gaseous bubbles) usually affect the viscosity of a fluid, the actual viscosity of a suspension is usually somewhat different from that of the continuous phase.

A substance is considered to be a fluid if it has an apparent viscosity less than 5,000 mPa·s (cP) (independent of any gel characteristic). For reference, the viscosity of pure water is about 1 mPa·s (cP).

Historically, to be considered to be suitable for use as a carrier fluid for a proppant for conventional reservoirs or applications such as gravel packing, it has been believed that a crosslinked gel needs to exhibit sufficient viscoelastic properties, in particular relatively high viscosities (e.g., at least about 300 mPa·s (300 cP)).

Biodegradability

Biodegradable means the process by which complex molecules are broken down by micro-organisms to produce simpler compounds. Biodegradation can be either aerobic (with oxygen) or anaerobic (without oxygen). The potential for biodegradation is commonly measured on well fluids or their components to ensure that they do not persist in the environment. A variety of tests exist to assess biodegradation.

As used herein, a substance is considered “biodegradable” if the substance passes a ready biodegradability test or an inherent biodegradability test. It is preferred that a substance is first tested for ready biodegradability, and only if the substance does not pass at least one of the ready biodegradability tests then the substance is tested for inherent biodegradability.

In accordance with Organisation for Economic Co-operation and Development (“OECD”) guidelines, the following six tests permit the screening of chemicals for ready biodegradability. As used herein, a substance showing more than 60% biodegradability in 28 days according to any one of the six ready biodegradability tests is considered a pass level for classifying it as “readily biodegradable,” and it may be assumed that the substance will undergo rapid and ultimate degradation in the environment. The six ready biodegradability tests are: (1) 301A: DOC Die-Away; (2) 301B: CO2 Evolution (Modified Sturm Test); (3) 301C: MITI (I) (Ministry of International Trade and Industry, Japan); (4) 301D: Closed Bottle; (5) 301E: Modified OECD Screening; and (6) 301F: Manometric Respirometry. The six ready biodegradability tests are described below:

For the 301A test, a measured volume of inoculated mineral medium, containing 10 mg to 40 mg dissolved organic carbon per liter (DOC/1) from the substance as the nominal sole source of organic carbon, is aerated in the dark or diffuse light at 22±2° C. Degradation is followed by DOC analysis at frequent intervals over a 28-day period. The degree of biodegradation is calculated by expressing the concentration of DOC removed (corrected for that in the blank inoculum control) as a percentage of the concentration initially present. Primary biodegradation may also be calculated from supplemental chemical analysis for parent compound made at the beginning and end of incubation.

For the 301B test, a measured volume of inoculated mineral medium, containing 10 mg to 20 mg DOC or total organic carbon per liter from the substance as the nominal sole source of organic carbon is aerated by the passage of carbon dioxide-free air at a controlled rate in the dark or in diffuse light. Degradation is followed over 28 days by determining the carbon dioxide produced. The CO₂ is trapped in barium or sodium hydroxide and is measured by titration of the residual hydroxide or as inorganic carbon. The amount of carbon dioxide produced from the test substance (corrected for that derived from the blank inoculum) is expressed as a percentage of ThCO₂. The degree of biodegradation may also be calculated from supplemental DOC analysis made at the beginning and end of incubation.

For the 301C test, the oxygen uptake by a stirred solution, or suspension, of the substance in a mineral medium, inoculated with specially grown, unadapted micro-organisms, is measured automatically over a period of 28 days in a darkened, enclosed respirometer at 25+/−1° C. Evolved carbon dioxide is absorbed by soda lime Biodegradation is expressed as the percentage oxygen uptake (corrected for blank uptake) of the theoretical uptake (ThOD). The percentage primary biodegradation is also calculated from supplemental specific chemical analysis made at the beginning and end of incubation, and optionally ultimate biodegradation by DOC analysis.

For the 301D test, a solution of the substance in mineral medium, usually at 2-5 milligrams per liter (mg/1), is inoculated with a relatively small number of micro-organisms from a mixed population and kept in completely full, closed bottles in the dark at constant temperature. Degradation is followed by analysis of dissolved oxygen over a 28 day period. The amount of oxygen taken up by the microbial population during biodegradation of the test substance, corrected for uptake by the blank inoculum run in parallel, is expressed as a percentage of ThOD or, less satisfactorily COD.

For the 301E test, a measured volume of mineral medium containing 10 to 40 mg DOC/1 of the substance as the nominal sole source of organic carbon is inoculated with 0.5 ml effluent per liter of medium. The mixture is aerated in the dark or diffused light at 22+2° C. Degradation is followed by DOC analysis at frequent intervals over a 28 day period. The degree of biodegradation is calculated by expressing the concentration of DOC removed (corrected for that in the blank inoculums control) as a percentage of the concentration initially present. Primary biodegradation may also be calculated from supplemental chemical analysis for the parent compound made at the beginning and end of incubation.

For the 301F test, a measured volume of inoculated mineral medium, containing 100 mg of the substance per liter giving at least 50 to 100 mg ThOD/1 as the nominal sole source of organic carbon, is stirred in a closed flask at a constant temperature (+1° C. or closer) for up to 28 days. The consumption of oxygen is determined either by measuring the quantity of oxygen (produced electrolytically) required to maintain constant gas volume in the respirometer flask or from the change in volume or pressure (or a combination of the two) in the apparatus. Evolved carbon dioxide is absorbed in a solution of potassium hydroxide or another suitable absorbent. The amount of oxygen taken up by the microbial population during biodegradation of the test substance (corrected for uptake by blank inoculum, run in parallel) is expressed as a percentage of ThOD or, less satisfactorily, COD. Optionally, primary biodegradation may also be calculated from supplemental specific chemical analysis made at the beginning and end of incubation, and ultimate biodegradation by DOC analysis.

In accordance with OECD guidelines, the following three tests permit the testing of chemicals for inherent biodegradability. As used herein, a substance with a biodegradation or biodegradation rate of >20% is regarded as “inherently primary biodegradable.” A substance with a biodegradation or biodegradation rate of >70% is regarded as “inherently ultimate biodegradable.” As used herein, a substance passes the inherent biodegradability test if the substance is either regarded as inherently primary biodegradable or inherently ultimate biodegradable when tested according to any one of three inherent biodegradability tests. The three tests are: (1) 302A: 1981 Modified SCAS Test; (2) 302B: 1992 Zahn-Wellens Test; and (3) 302C: 1981 Modified MITI Test Inherent biodegradability refers to tests which allow prolonged exposure of the test compound to microorganisms, a more favorable test compound to biomass ratio, and chemical or other conditions which favor biodegradation. The three inherent biodegradability tests are described below:

For the 302A test, activated sludge from a sewage treatment plant is placed in an aeration (SCAS) unit. The substance and settled domestic sewage are added, and the mixture is aerated for 23 hours. The aeration is then stopped, the sludge allowed to settle and the supernatant liquor is removed. The sludge remaining in the aeration chamber is then mixed with a further aliquot of the substance and sewage and the cycle is repeated. Biodegradation is established by determination of the dissolved organic carbon content of the supernatant liquor. This value is compared with that found for the liquor obtained from a control tube dosed with settled sewage only.

For the 302B test, a mixture containing the substance, mineral nutrients, and a relatively large amount of activated sludge in aqueous medium is agitated and aerated at 20° C. to 25° C. in the dark or in diffuse light for up to 28 days. A blank control, containing activated sludge and mineral nutrients but no substance, is run in parallel. The biodegradation process is monitored by determination of DOC (or COD) in filtered samples taken at daily or other time intervals. The ratio of eliminated DOC (or COD), corrected for the blank, after each time interval, to the initial DOC value is expressed as the percentage biodegradation at the sampling time. The percentage biodegradation is plotted against time to give the biodegradation curve.

For the 302C test, an automated closed-system oxygen consumption measuring apparatus (BOD-meter) is used. The substance to be tested is inoculated in the testing vessels with micro-organisms. During the test period, the biochemical oxygen demand is measured continuously by means of a BOD-meter. Biodegradability is calculated on the basis of BOD and supplemental chemical analysis, such as measurement of the dissolved organic carbon concentration, concentration of residual chemicals, etc.

General Measurement Terms

Unless otherwise specified or unless the context otherwise clearly requires, any ratio or percentage means by weight.

If there is any difference between U.S. or Imperial units, U.S. units are intended.

Unless otherwise specified, mesh sizes are in U.S. Standard Mesh.

The micrometer (μm) may sometimes be referred to herein as a micron.

The conversion between pound per gallon (lb/gal or ppg) and kilogram per cubic meter (kg/m³) is: 1 lb/gal=(0.4536 kg/lb)×(gal/0.003785 m³)=120 kg/m³.

### General Approach

The invention provides a well fluid comprising an oleaginous continuous phase, a gelling agent for oil, wherein the gelling agent is based on an amino acid, and a solid particulate.

In an embodiment, a well fluid is provided, the well fluid including: (i) an oleaginous continuous phase; (ii) an N-acyl amino acid alkylamide; and (iii) a solid particulate.

In another embodiment, a method of treating a portion of a well with a particulate is provided, the method including the steps of: (A) forming the well fluid; and (B) introducing the well fluid into the well.

In another embodiment, a well fluid in the form of an invert emulsion is provided. The N-acyl amino acid alkylamide affords an invert emulsion with a high OWR ratio, that is, greater than 40% oil by volume, preferably greater than 60:40 OWR, for example, about 70:30 OWR. The OWR used for the fluid of this invention affords a carrier fluid of low viscosity. For example, the fluid can have a viscosity value less than about 50 cP, preferably less than about 40 cP. The invert emulsion has a low viscosity, but can still suspend proppant or gravel. The low viscosity of the invert emulsion fluid eliminates the need to break the emulsion during flow-back. In addition, the fluid has lower frictional pressures than the frictional pressures associated with using higher viscosity fluid. Such a well fluid has particular use in treating water-sensitive formations with a fluid for carrying a particulate.

### Viscosity-Increasing Agent (Gelling Agent)

Preferably, the gelling agent is an N-acyl amino acid alkylamide is represented by formula:

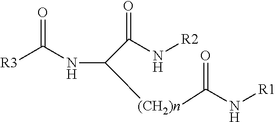

wherein R1 and R2 each independently represent a straight chain or branched chain saturated or unsaturated hydrocarbon group having 1 to 30 carbon atoms,
wherein R3 represents a straight chain or branched chain saturated or unsaturated hydrocarbon group having 1 to 30 carbon atoms, and
wherein n represents 1 or 2.

Preferably, R1 and R2 each independently represent a straight chain or branched chain saturated or unsaturated hydrocarbon group having 2 to 12 carbon atoms.

Preferably, R1 and R2 are the same, for example, the N-acyl amino acid alkylamide is an N-acyl-amino acid dialkyamide.

Preferably, R3 represents a straight chain or branched chain saturated or unsaturated hydrocarbon group having 4 to 18 carbon atoms.

Preferred N-acyl amino acid alkylamides are prepared from the group consisting of glutamic acid, lysine, glutamine, aspartic acid, and mixtures thereof. Particularly preferred are n-acyl glutamic acid alkylamides. Most preferably, the glutamic acid is an L-glutamic acid.

Examples of the above include N-lauroyl-L-glutamic acid dibutylamide, N-2-ethylhexanoyl-L-glutamic acid dibutylamide, N-stearoyl-L-glutamic acid diheptyl amide, and mixtures thereof

N-lauroyl-L-glutamic acid dibutylamide, also referred to as dibutyllauroyl glutamide, CTFA INCI Name “Dibutyl Lauroyl Glutamide” (CAS Reg. No. 63663-21-8) is commercially available from Ajinomoto Co., Inc., USA, under the trade name “Gelatinization Agent GP-1” and it is also commercially available from Hampshire Chemical Corporation, a subsidiary of Dow Chemical Company, under the trade name “LGB”. The chemical structure of N-lauroyl-L-glutamic acid dibulylamide is:

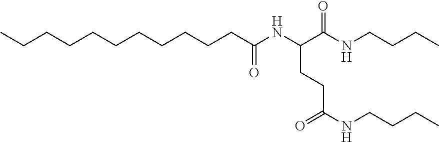 [SMILES: CCCCCCCCCCCC(=O)NC(CCC(=O)NCCCC)C(=O)NCCCC]

N-2-ethylhexanoyl-L-glutamic acid dibutylamide, CTFA INCI Name “Dibutyl Ethylhexanoyl Glutamide” (CAS Reg. No. 861390-34-3) is commercially available from Ajinomoto Co., Inc. “Gelatinization Agent GB-21”. The chemical structure of N-2-ethylhexanoyl-L-glutamic acid dibutylamide is:

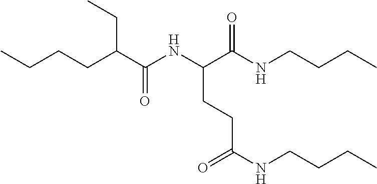 [SMILES: CCCCNC(=O)CCC(NC(=O)C(CC)CCCC)C(=O)NCCCC]

N-lauroyl-L-glutamic acid dibutylamide, N-2-ethylhexanoyl-L-glutamic acid dibutylamide, and N-stearoyl-L-glutamic acid diheptyl amide, are examples of highly effective gelling agents for oil based on an amino acid. Such oil-gelling agents are believed to form nano-sized fiber networks in oils. To obtain effective gelling of the oil, such oil gelling agents can either be used alone, or in a combination of the two, or with other gelling agents. MSDS data for these materials shows that the additives are expected to be biodegradable and have low eco-toxicity.

Most preferably, the N-acyl amino acid alkylamide is selected from the group consisting of: N-lauroyl-L-glutamic acid dibutylamide, N-2-ethylhexanoyl-L-glutamic acid dibutylamide, and any combination thereof.

Preferably, the N-acyl amino acid alkylamide is selected for being biodegradable.

The gelling agent can be provided in any form that is suitable for the particular treatment fluid or application. For example, the gelling agent can be provided as a liquid, gel, suspension, or solid additive that is incorporated into a treatment fluid.

The gelling agent should be present in a treatment fluid in a form and in an amount at least sufficient to impart a desired viscosity to a treatment fluid. Preferably, the one or more gelling agents may be present in the well fluids in a concentration in the range of from about 0.01% to about 5% by weight of the continuous phase. More preferably, the one or more gelling agents are in concentration in the range of from about 0.1% to about 3% by weight of the continuous phase. Most preferably, the one or more gelling agents are in concentration in the range of from about 0.5% to about 2% by weight of the continuous phase.

Additional information regarding such gelling agents is disclosed in: patent publication US 2007/0265347, published Nov. 15, 2007, entitled “Encapsulated Oil-in-Water Type Emulsion Composition,” and issued to Ajinomoto Co. Inc. (Tokyo, Japan); U.S. Pat. No. 7,199,101, issued Apr. 3, 2007, entitled “Gelling Agent for Oil,” and issued to Ajinomoto Co., Inc. (Tokyo, Japan); and Patent publication US 2011/0177019, published Jul. 21, 2011, entitled “Gelled Water-in-Oil Micro Emulsions for Hair Treatment,” having for named inventors Kevin Brian Dickinson, et al.; each of which is incorporated by reference in entirety.

### Oleaginous Continuous Phase

Preferably, the oleaginous phase of the well fluid includes a natural or synthetic source of an oil. Examples of oils from natural sources include, without limitation, kerosene, diesel, crude oil, gas oil, fuel oil, paraffin oil, mineral oil, low toxicity mineral oil, other petroleum distillates, and combinations thereof. Examples of synthetic oils include, without limitation, polyolefins, n-paraffins, iso-paraffins, n-alkanes, cyclic alkanes, branched alkanes, esters, polydiorganosiloxanes, siloxanes, organosiloxanes, and mixtures thereof. Most preferably, the oleaginous phase includes paraffin oil.

Preferably, the oleaginous continuous phase comprises at least 40% of the liquid volume of the well fluid (excluding the volume of solid particulate). More preferably, the oleaginous continuous phase comprises at least 50% of the liquid volume of the well fluid. More preferably, the oleaginous continuous phase comprises at least 60% of the liquid volume of the well fluid.

### Particulate

The treatment fluid includes a particulate. A particulate, such as proppant or gravel, can be used. Examples include sand, gravel, bauxite, ceramic materials, glass materials, polymer materials, wood, plant and vegetable matter, nut hulls, walnut hulls, cottonseed hulls, cured cement, fly ash, fibrous materials, composite particulates, hollow spheres or porous particulate.

In addition, particulate that has been chemically treated or coated may also be used. The term “coated” does not imply any particular degree of coverage of the particulates with the resin or tackifying agent.

Treatment fluids comprising particulates may be used in any method known in the art that requires the placement of particulates in a subterranean formation. For example, treatment fluids that comprise particulates may be used, inter alia, to form a gravel pack in or adjacent to a portion of the subterranean formation.

Preferably, the particulate of the well fluid has an average particle size greater than 100 US mesh. More preferably, the particulate of the well fluid has a particulate size in the range of about 100 US mesh to about 4 US mesh. Preferably, the particulate has a size less than about 2 mm diameter.

Preferably, the particulate is selected from the group consisting of proppant, gravel, and any combination thereof.

### Additional Discontinuous Liquid Phase

Preferably, the well fluid additionally includes a discontinuous liquid phase. Preferably, the discontinuous liquid phase is or includes water.

The water for use in the well fluid should not contain anything that would adversely interact with the other components used in the well fluid.

The aqueous phase can include freshwater or non-freshwater. Non-freshwater sources of water can include surface water ranging from brackish water to seawater, brine, returned water (sometimes referred to as flowback water) from the delivery of a well fluid into a well, unused well fluid, and produced water. As used herein, brine refers to water having at least 40,000 mg/L total dissolved solids.

Salts may optionally be included in the treatment fluids for many purposes. For example, salts may be added to a water source, for example, to provide a brine, and a resulting treatment fluid, having a desired density. Salts may optionally be included for reasons related to compatibility of the treatment fluid with the formation and formation fluids. To determine whether a salt may be beneficially used for compatibility purposes, a compatibility test may be performed to identify potential compatibility problems. From such tests, one of ordinary skill in the art with the benefit of this disclosure will be able to determine whether a salt should be included in a treatment fluid.

Suitable salts can include, but are not limited to, calcium chloride, sodium chloride, magnesium chloride, potassium chloride, sodium bromide, potassium bromide, ammonium chloride, sodium formate, potassium formate, cesium formate, mixtures thereof, and the like. The amount of salt that should be added should be the amount necessary for formation compatibility, such as stability of clay minerals, taking into consideration the crystallization temperature of the brine, e.g., the temperature at which the salt precipitates from the brine as the temperature drops.

More preferably, the discontinuous liquid phase includes an inorganic salt. Preferably, the discontinuous liquid phase includes at least 2% by weight of one or more inorganic salts. More preferably, the discontinuous liquid phase is a brine.

The discontinuous liquid phase preferably has a density greater than 8.5 ppg. More preferably, the discontinuous liquid phase can have a density range of 8.5 ppg to 19 ppg, depending upon the desired density of the invert emulsion as a whole.

Preferably, a discontinuous liquid phase of water has a pH in the range of 5 to 9. More preferably, the discontinuous liquid phase has a pH in the range of 5 to 8.

The discontinuous phase can include a pH-adjuster. Preferably, the pH adjuster does not have undesirable properties for the well fluid. A pH-adjuster can be present in the water phase in an amount sufficient to adjust the pH to within the desired range.

### Emulsifier

Preferably, the well fluid additionally includes an emulsifier. This is especially helpful if the well fluid is an emulsion. The emulsifier is selected based on the particular nature of the oleaginous continuous phase and any other liquid phase desired to be emulsified with the well fluid, either before introducing the well fluid into a well or downhole.

In an embodiment, the emulsifier is selected from the group consisting of: polyaminated fatty acids and their salts, quaternary ammonium compounds, and tallow based compounds.

Preferably, the emulsifier is a ionic surfactant. More preferably, the emulsifier is selected from the group consisting of: an polyolefin amide, an alkeneamide, a polyaminated fatty acid, and any combination thereof. Most preferably, the emulsifier is or includes a polyaminated fatty acid.

Preferably, the emulsifier has an HLB (Griffin) in the range of 3 to 8. Preferably, the emulsifier has an HLB in the range of 4 to 6.

### Other Well Fluid Additives

A well fluid can contain other additives that are commonly used in oil field applications, as known to those skilled in the art. These include, but are not necessarily limited to, brines, inorganic water-soluble salts, salt substitutes (such as trimethyl ammonium chloride), pH control additives, surfactants, breakers, breaker aids, oxygen scavengers, alcohols, scale inhibitors, corrosion inhibitors, hydrate inhibitors, fluid-loss control additives, oxidizers, chelating agents, water control agents (such as relative permeability modifiers), consolidating agents, proppant flowback control agents, conductivity enhancing agents, clay stabilizers, sulfide scavengers, fibers, nanoparticles, bactericides, and any combination thereof.

Of course, additives should be selected for not interfering with the purpose of the well fluid.

### Hot Rolling Well Fluid Prior to Use

Preferably, the well fluid is hot rolled prior to use. A purpose of hot rolling the well fluid is to activate or condition the continuous oleaginous phase and the gelling agent. In addition, in the case of a well fluid that is an emulsion, hot rolling can help stabilize the emulsified fluid prior to use. After being hot rolled, the fluid is stable at lower temperatures, for example, under Standard Laboratory Conditions.

Preferably, the well fluid is hot rolled for at least 2 hours at a temperature of at least 250° F. More preferably, the hot-rolling temperature is less than about 300° F. Preferably, the well fluid is hot rolled in the range of about 20 revolutions per minute.

Method of Treating a Well with the Well Fluid

According to an embodiment of the invention, a method of treating a well is provided, the method including the steps of: forming a treatment fluid according to the invention; and introducing the treatment fluid into the well. The method can be used, for example, in hydraulic fracturing or gravel packing.

A well fluid can be prepared at the job site, prepared at a plant or facility prior to use, or certain components of the well fluid can be pre-mixed prior to use and then transported to the job site. Certain components of the well fluid may be provided as a “dry mix” to be combined with fluid or other components prior to or during introducing the well fluid into the well.

In certain embodiments, the preparation of a well fluid can be done at the job site in a method characterized as being performed “on the fly.” The term “on-the-fly” is used herein to include methods of combining two or more components wherein a flowing stream of one element is continuously introduced into flowing stream of another component so that the streams are combined and mixed while continuing to flow as a single stream as part of the on-going treatment. Such mixing can also be described as “real-time” mixing.

Preferably, the step of introducing a well fluid into a well is within a relatively short period after forming the well fluid, e.g., less within 30 minutes to one hour. More preferably, the step of introducing the well fluid is immediately after the step of forming the well fluid, which is “on the fly.”

It should be understood that the step of delivering a well fluid into a well can advantageously include the use of one or more fluid pumps.

In an embodiment, the step of introducing comprises introducing under conditions for fracturing a treatment zone. The fluid is introduced into the treatment zone at a rate and pressure that are at least sufficient to fracture the zone.

In an embodiment, the step of introducing is at a rate and pressure below the fracture pressure of the treatment zone.

In an embodiment, the step of introducing comprises introducing under conditions for gravel packing the treatment zone.

Preferably, the step of flowing back is within one week of the step of introducing. More preferably, the step of flowing back is within 24 hours of the step of introducing.

Preferably, after any such well treatment, a step of producing hydrocarbon from the subterranean formation is the desirable objective.

### Hydraulic Fracturing

Hydraulic fracturing is a common stimulation treatment. The purpose of a hydraulic fracturing treatment is to provide an improved flow path for oil or gas to flow from the hydrocarbon-bearing formation to the wellbore. In addition, a fracturing treatment can facilitate the flow of injected treatment fluids from the well into the formation. A treatment fluid adapted for this purpose is sometimes referred to as a fracturing fluid. The fracturing fluid is pumped at a sufficiently high flow rate and pressure into the wellbore and into the subterranean formation to create or enhance one or more fractures in the subterranean formation. Creating a fracture means making a new fracture in the formation Enhancing a fracture means enlarging a pre-existing fracture in the formation.

A newly-created or newly-extended fracture will tend to close together after the pumping of the fracturing fluid is stopped. To prevent the fracture from closing, a material is usually placed in the fracture to keep the fracture propped open and to provide higher fluid conductivity than the matrix of the formation. A material used for this purpose is referred to as a proppant.

A proppant is in the form of a solid particulate, which can be suspended in the fracturing fluid, carried downhole, and deposited in the fracture to form a proppant pack. The proppant pack props the fracture in an open condition while allowing fluid flow through the permeability of the pack. The proppant pack in the fracture provides a higher-permeability flow path for the oil or gas to reach the wellbore compared to the permeability of the matrix of the surrounding subterranean formation. This higher-permeability flow path increases oil and gas production from the subterranean formation.

A particulate for use as a proppant is usually selected based on the characteristics of size range, crush strength, and solid stability in the types of fluids that are encountered or used in wells. Preferably, a proppant should not melt, dissolve, or otherwise degrade from the solid state under the downhole conditions.

The proppant is selected to be an appropriate size to prop open the fracture and bridge the fracture width expected to be created by the fracturing conditions and the fracturing fluid. If the proppant is too large, it will not easily pass into a fracture and will screenout too early. If the proppant is too small, it will not provide the fluid conductivity to enhance production. See, for example, W. J. McGuire and V. J. Sikora, “The Effect of Vertical Fractures on Well Productivity,” Trans., AIME (1960) 219, 401-403. In the case of fracturing relatively permeable or even tight-gas reservoirs, a proppant pack should provide higher permeability than the matrix of the formation. In the case of fracturing ultra-low permeable formations, such as shale formations, a proppant pack should provide for higher permeability than the naturally occurring fractures or other micro-fractures of the fracture complexity.

Appropriate sizes of particulate for use as a proppant are typically in the range from about 8 to about 100 U.S. Standard Mesh. A typical proppant is sand-sized, which geologically is defined as having a largest dimension ranging from about 0.06 millimeters up to about 2 millimeters (mm) (The next smaller particle size class below sand size is silt, which is defined as having a largest dimension ranging from less than about 0.06 mm down to about 0.004 mm.) As used herein, proppant does not mean or refer to suspended solids, silt, fines, or other types of insoluble solid particulate smaller than about 0.06 mm (about 230 U.S. Standard Mesh). Further, it does not mean or refer to particulates larger than about 3 mm (about 7 U.S. Standard Mesh).

The proppant is sufficiently strong, that is, has a sufficient compressive or crush resistance, to prop the fracture open without being deformed or crushed by the closure stress of the fracture in the subterranean formation. For example, for a proppant material that crushes under closure stress, a 20/40 mesh proppant preferably has an API crush strength of at least 4,000 psi closure stress based on 10% crush fines according to procedure API RP-56. A 12/20 mesh proppant material preferably has an API crush strength of at least 4,000 psi closure stress based on 16% crush fines according to procedure API RP-56. This performance is that of a medium crush-strength proppant, whereas a very high crush-strength proppant would have a crush-strength of about 10,000 psi. In comparison, for example, a 100-mesh proppant material for use in an ultra-low permeable formation such as shale preferably has an API crush strength of at least 5,000 psi closure stress based on 6% crush fines. The higher the closing pressure of the formation of the fracturing application, the higher the strength of proppant is needed. The closure stress depends on a number of factors known in the art, including the depth of the formation.

Further, a suitable proppant should be stable over time and not dissolve in fluids commonly encountered in a well environment. Preferably, a proppant material is selected that will not dissolve in water or crude oil.

Suitable proppant materials include, but are not limited to, sand (silica), ground nut shells or fruit pits, sintered bauxite, glass, plastics, ceramic materials, processed wood, resin coated sand or ground nut shells or fruit pits or other composites, and any combination of the foregoing. Mixtures of different kinds or sizes of proppant can be used as well. In conventional reservoirs, if sand is used, it commonly has a median size anywhere within the range of about 20 to about 100 U.S. Standard Mesh. For a synthetic proppant, it commonly has a median size anywhere within the range of about 8 to about 100 U.S. Standard Mesh.

The concentration of proppant in the treatment fluid depends on the nature of the subterranean formation. As the nature of subterranean formations differs widely, the concentration of proppant in the treatment fluid may be in the range of from about 0.03 kilograms to about 12 kilograms of proppant per liter of liquid phase (from about 0.1 lb/gal to about 25 lb/gal).

Designing a fracturing treatment usually includes determining a designed total pumping time for the treatment of the treatment zone or determining a designed total pumping volume of fracturing fluid for the treatment zone. A person of skill in the art is able to plan each fracturing treatment in detail, subject to unexpected or undesired early screenout or other problems that might be encountered in fracturing a well. A person of skill in the art is able to determine the wellbore volume between the wellhead and the zone. In addition, a person of skill in the art is able to determine the time within a few seconds in which a well fluid pumped into a well should take to reach a zone.

Fracturing methods can include a step of designing or determining a fracturing treatment for a treatment zone of the subterranean formation prior to performing the fracturing stage. For example, a step of designing can include: (a) determining the design temperature and design pressure; (b) determining the total designed pumping volume of the one or more fracturing fluids to be pumped into the treatment zone at a rate and pressure above the fracture pressure of the treatment zone; (c) designing a fracturing fluid, including its composition and rheological characteristics; (d) designing the pH of the continuous phase of the fracturing fluid, if water-based; (e) determining the size of a proppant of a proppant pack previously formed or to be formed in fractures in the treatment zone; and (f) designing the loading of any proppant in the fracturing fluid.

### Sand Control and Gravel Packing

Gravel packing is commonly used as a sand-control method to prevent production of formation sand or other fines from a poorly consolidated subterranean formation. In this context, “fines” are tiny particles, typically having a diameter of 43 microns or smaller, that have a tendency to flow through the formation with the production of hydrocarbon. The fines have a tendency to plug small pore spaces in the formation and block the flow of oil. As all the hydrocarbon is flowing from a relatively large region around the wellbore toward a relatively small area around the wellbore, the fines have a tendency to become densely packed and screen out or plug the area immediately around the wellbore. Moreover, the fines are highly abrasive and can be damaging to pumping and oilfield other equipment and operations.

Placing a relatively larger particulate near the wellbore helps filter out the sand or fine particles and prevents them from flowing into the well with the produced fluids. The primary objective is to stabilize the formation while causing minimal impairment to well productivity.

The particulate used for this purpose is referred to as “gravel.” In the oil and gas field, and as used herein, the term “gravel” is refers to relatively large particles in the sand size classification, that is, particles ranging in diameter from about 0.1 mm up to about 2 mm. Generally, a particulate having the properties, including chemical stability, of a low-strength proppant is used in gravel packing. An example of a commonly used gravel packing material is sand having an appropriate particulate size range. For various purposes, the gravel particulates also may be coated with certain types of materials, including resins, tackifying agents, and the like. For example, a tackifying agent can help with fines and resins can help to enhance conductivity (e.g., fluid flow) through the gravel pack.

In one common type of gravel packing, a mechanical screen is placed in the wellbore and the surrounding annulus is packed with a particulate of a larger specific size designed to prevent the passage of formation sand or other fines. The screen holds back gravel during flow back. It is also common, for example, to gravel pack after a fracturing procedure, and such a combined procedure is sometimes referred to as a “frac-packing.”

A screenout is a condition encountered during some gravel-pack operations wherein the treatment area cannot accept further packing gravel (larger sand). Under ideal conditions, this should signify that the entire void area has been successfully packed with the gravel. However, if screenout occurs earlier than expected in the treatment, it may indicate an incomplete treatment and the presence of undesirable voids within the treatment zone.

In some gravel packing applications, a resinous material can be coated on the proppant. The term “coated” does not imply any particular degree of coverage on the proppant particulates, which coverage can be partial or complete.

As used herein, the term “resinous material” means a material that is a viscous liquid and has a sticky or tacky characteristic when tested under Standard Laboratory Conditions. A resinous material can include a resin, a tackifying agent, and any combination thereof in any proportion. The resin can be or include a curable resin.

Gravel packing methods can include a step of designing or determining a gravel packing treatment for a treatment zone of the subterranean formation. According to an embodiment, the step of designing can include: (a) determining the design temperature and design pressure; (b) determining the total designed pumping volume of the one or more treatment fluids to be pumped into the treatment zone; (c) determining the pumping time and rate; (d) designing the treatment fluid, including its composition and rheological characteristics; (e) designing the pH of the continuous phase of the treatment fluid, if water-based; (f) determining the size of a gravel; and (g) designing the loading of the gravel in the fluid.

### EXAMPLES

To facilitate a better understanding of the present invention, the following examples of certain aspects of some embodiments are given. In no way should the following examples be read to limit, or define, the entire scope of the invention.

The suspension characteristic of a gelling agent for use in a fluid according to the invention was tested as below:

Step 1. 200 ml of brine in oil invert emulsion fluid was prepared having an OWR of 70:30 and comprising N-lauroyl-L-glutamic acid dibulylamide as a gelling agent. Table 1 gives the list of additives and their order of addition. The formulated invert emulsion fluid was then placed in an aging cell and a pressure of 100 psi was applied to it.

Step 2. The invert emulsion fluid placed in the aging cell was hot rolled at about 20 rpm in a roller oven at 250° F. for 2 hours to initiate the activation process. It was then cooled in a water bath for 30 minutes. An aging cell is a cylindrical container made of stainless steel usually used for hot rolling of mud sample under pressure.

Step 3. The fluid was then transferred into a mixing cup and was mixed for 5 minutes.

Step 4. The viscosity of the fluid measured at 300 rpm was 34 mPa·S (34 cP).

Step 5. Next, 96 grams of 20-40 US mesh CARBOLTE™ sand was added to the invert emulsion fluid placed in the mixing cup and mixed well using a multimixer for 5 minutes. CARBOLITE™ sand is a ceramic proppant of semi-crystalline alumina silicate, which is commercially available from Carbo Ceramics, Louisiana, USA.

Step 6. The contents of the mixing cup were transferred into a 100 ml measuring cylinder and the extent of sand settling and oil separation was recorded after 0 minutes, 30 minutes, and 16 hours at room temperature. Sand remained in the suspended state even after 16 hours.

An example of an OWR composition and the test results are shown in Table 1.

TABLE 1

| | Mixing | |
|---|---|---|
| 70/30 OWR Composition | time (min) | Fluid |
| Synthetic paraffin (normal alkanes), grams | — | 140 |
| A polyaminated fatty acid as emulsifier, grams | 2 | 7 |
| Lime (Ca(OH)₂) as alkalinity control agent, grams | 2 | 1.5 |
| N-lauroyl-L-glutamic acid dibutylamide, grams | 5 | 3.5 |
| 25% CaCl₂ brine, ml | 5 | 60 ml |
| 20-40 CARBOLITE ™ sand, grams | 5 | 96 g |
| Initial density (weight of the fluid in the absence | | 7.5 |
| of sand), ppg | | |
| Final density, ppg (weight of the fluid after adding | | 10 |
| 20-40 US mesh CARBOLITE ™ sand) | | |
| Viscosity, cP @ 300 rpm on Fann 35 | | 34 |
| Oil separation after 16 hours, ml | | 2 |

Accordingly, in an embodiment, the fluid is an invert emulsion gravel-pack fluid for gravel packing, wherein the fluid includes a gelling agent based on L glutamic acid. The fluid has greater than 50% by weight oil by volume, preferably greater than 60:40 OWR. The OWR used for the fluid of this invention affords a carrier fluid of low viscosity. For example, the fluid can have a viscosity value less than about 50 cP, preferably less than about 40 cP. The low viscosity fluid eliminates the need for a step of breaking the emulsion during flow-back and also reduces the frictional pressures associated with using a high viscosity fluid.

### CONCLUSION

Therefore, the present invention is well adapted to attain the ends and advantages mentioned as well as those that are inherent therein.

The exemplary fluids disclosed herein may directly or indirectly affect one or more components or pieces of equipment associated with the preparation, delivery, recapture, recycling, reuse, or disposal of the disclosed fluids. For example, the disclosed fluids may directly or indirectly affect one or more mixers, related mixing equipment, mud pits, storage facilities or units, fluid separators, heat exchangers, sensors, gauges, pumps, compressors, and the like used generate, store, monitor, regulate, or recondition the exemplary fluids. The disclosed fluids may also directly or indirectly affect any transport or delivery equipment used to convey the fluids to a well site or downhole such as, for example, any transport vessels, conduits, pipelines, trucks, tubulars, or pipes used to fluidically move the fluids from one location to another, any pumps, compressors, or motors (e.g., topside or downhole) used to drive the fluids into motion, any valves or related joints used to regulate the pressure or flow rate of the fluids, and any sensors (i.e., pressure and temperature), gauges, or combinations thereof, and the like. The disclosed fluids may also directly or indirectly affect the various downhole equipment and tools that may come into contact with the chemicals/fluids such as, but not limited to, drill string, coiled tubing, drill pipe, drill collars, mud motors, downhole motors or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

The particular embodiments disclosed above are illustrative only, as the present invention may be modified and practiced in different but equivalent manners apparent to those skilled in the art having the benefit of the teachings herein. It is, therefore, evident that the particular illustrative embodiments disclosed above may be altered or modified and all such variations are considered within the scope and spirit of the present invention.

The various elements or steps according to the disclosed elements or steps can be combined advantageously or practiced together in various combinations or sub-combinations of elements or sequences of steps to increase the efficiency and benefits that can be obtained from the invention.

The invention illustratively disclosed herein suitably may be practiced in the absence of any element or step that is not specifically disclosed or claimed.

Furthermore, no limitations are intended to the details of construction, composition, design, or steps herein shown, other than as described in the claims.

What is claimed is:

1. A well fluid comprising:
(i) an oleaginous continuous phase;
(ii) an N-acyl amino acid alkylamide; and
(iii) a solid particulate.

2. The well fluid according to claim 1, wherein the N-acyl amino acid alkylamide is represented by formula: 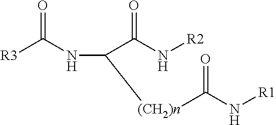
wherein R1 and R2 each independently represent a straight chain or branched chain saturated or unsaturated hydrocarbon group having 1 to 30 carbon atoms,
wherein R3 represents a straight chain or branched chain saturated or unsaturated hydrocarbon group having 1 to 30 carbon atoms, and
wherein n represents 1 or 2.

3. The well fluid according to claim 1, wherein the N-acyl amino acid alkylamide is selected from the group consisting of: N-lauroyl-L-glutamic acid dibutylamide, N-2-ethylhexanoyl-L-glutamic acid dibutylamide, and any combination thereof.

4. The well fluid according to claim 1, wherein the oleaginous continuous phase comprises at least 40% of the liquid volume of the well fluid.

5. The well fluid according to claim 1, wherein the particulate has an average particle size between 100 US mesh and 4 US mesh.

6. The well fluid according to claim 1, wherein the particulate is selected from the group consisting of proppant or gravel.

7. The well fluid according to claim 1, wherein the well fluid additionally comprises: a discontinuous liquid phase.

8. The well fluid according to claim 1, wherein the well fluid additionally comprises an emulsifier.

9. The well fluid according to claim 8, wherein the emulsifier has an HLB (Griffin) in the range of 3 to 8.

10. The well fluid according to claim 1, wherein the well fluid is hot rolled.

11. A method of treating a portion of a well with a particulate, the method comprising the steps of:
(A) forming a well fluid comprising:
(i) an oleaginous continuous phase;
(ii) an N-acyl amino acid alkylamide; and
(iii) a solid particulate; and
(B) introducing the well fluid into the well.

12. The method according to claim 11, wherein the N-acyl amino acid alkylamide is represented by formula: 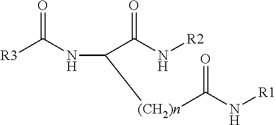
wherein R1 and R2 each independently represent a straight chain or branched chain saturated or unsaturated hydrocarbon group having 1 to 30 carbon atoms,
wherein R3 represents a straight chain or branched chain saturated or unsaturated hydrocarbon group having 1 to 30 carbon atoms, and
wherein n represents 1 or 2.

13. The method according to claim 11, wherein the N-acyl amino acid alkylamide is selected from the group consisting of: N-lauroyl-L-glutamic acid dibutylamide, N-2-ethylhexanoyl-L-glutamic acid dibutylamide, and any combination thereof.

14. The method according to claim 11, wherein the oleaginous continuous phase comprises at least 40% of the liquid volume of the well fluid.

15. The method according to claim 11, wherein the particulate has an average particle size between 100 US mesh and 4 US mesh.

16. The method according to claim 11, wherein the particulate is selected from the group consisting of proppant or gravel.

17. The method according to claim 11, wherein the well fluid additionally comprises: a discontinuous liquid phase.

18. The method according to claim 11, wherein the well fluid additionally comprises: an emulsifier.

19. The method according to claim 18, wherein the emulsifier has an HLB (Griffin scale) in the range of 3 to 8.

20. The method according to claim 1, wherein the well fluid is hot rolled prior to introducing into the well.

21-41. (canceled)
